(19) United States
(12) Patent Application Publication
(10) Pub. No.: US 2016/0345541 A1
(43) Pub. Date: Dec. 1, 2016

(54) LOCKING MECHANISM FOR PET RETRACTOR

(71) Applicant: Fong-O LAI, (US)

(72) Inventor: Fong-O LAI, Taichung (TW)

(21) Appl. No.: 14/723,540

(22) Filed: May 28, 2015

(51) Int. Cl. A01K 27/00; B65H 75/44; A01K 29/00

(52) U.S. Cl. CPC A01K 27/004; A01K 29/00; B65H 75/4431

(57) ABSTRACT

A pet retractor includes a housing having a spindle and having a guide channel and two seats, a rotary member engaged in the housing for engaging with a pet leash, and the rotary member has a number of ratchet teeth, a spring biasing member is engaged between the rotary member and the housing for recovering the rotary member relative to the housing, and a lock device includes a base slidably engaged in the guide channel of the housing and engageable into the housing for engaging with the ratchet teeth of the rotary member, a knob is pivotally attached to the base and includes a latch member for engaging with either of the seats of the housing.

### BACKGROUND OF THE INVENTION

1. Field of the Invention

The present invention relates to a pet retractor or retracting leash, and more particularly to a pet retractor including a locking mechanism for solidly and stably locking and releasing the cable or cord and for increasing the working life of the locking mechanism for the pet retractor.

2. Description of the Prior Art

Various kinds of typical retracting leash or pet retractors have been developed and provided for coiling or receiving and releasing the cable or cord for pet, and comprise a pulley rotatably received in a housing for winding or receiving the cable or cord for pet, and a locking mechanism attached or mounted to the housing for selectively engaging with the pulley and for locking and releasing the cable or cord for the pet.

For example, U.S. Pat. No. 6,273,354 to Kovacik et al., U.S. Pat. No. 6,352,213 to Sumiyashiki et al., U.S. Pat. No. 6,530,536 to Sumiyashiki et al., U.S. Pat. No. 6,694,922 to Walter et al., U.S. Pat. No. 7,744,030 to Sumiyashiki, U.S. Pat. No. 7,784,728 to Shi, U.S. Pat. No. 8,516,979 to Ek, and U.S. Pat. No. 8,826,864 to Tang disclose several of the typical retracting leash or pet retractors each also comprising a pulley rotatably received in a housing for receiving or engaging with the cable or cord for pet, and a locking mechanism attached or mounted to the housing for selectively engaging with the pulley and for locking and releasing the cable or cord for the pet.

However, the locking mechanism for the pet retractor includes a structure or configuration that may be easily and quickly damaged after use, and the cable or cord for the pet may not be solidly and stably locked to the housing after use.

The present invention has arisen to mitigate and/or obviate the afore-described disadvantages of the conventional retracting leash or pet retractors.

### SUMMARY OF THE INVENTION

The primary objective of the present invention is to provide a pet retractor including a locking mechanism for solidly and stably locking and releasing the cable or cord for pet, and for being easily actuated or operated by the user, and for increasing the working life of the locking mechanism for the pet retractor.

In accordance with one aspect of the invention, there is provided a pet retractor comprising a housing including a chamber formed therein, and including a spindle provided in the chamber of the housing, and including a guide channel formed in the housing and communicating with the chamber of the housing, the housing including a first seat and a second seat provided therein, a rotary member rotatably engaged in the chamber of the housing for engaging with a pet leash, and the rotary member being rotatably engaged with the spindle of the housing, the rotary member including a number of ratchet teeth extended therefrom, a spring biasing member engaged between the rotary member and the housing for recovering the rotary member relative to the housing, and a lock device including a base slidably engaged in the guide channel of the housing and engageable into the chamber of the housing for engaging with the ratchet teeth of the rotary member, a knob pivotally attached to the base and slidably received and engaged in the guide channel of the housing and partially extendible out of the housing, the knob including a latch member extended therefrom for selectively engaging with either of the first seat or the second seat of the housing, and a spring biasing element engaged between the base and the housing for biasing and forcing the base to move away from the ratchet teeth of the rotary member, and for biasing and forcing the latch member of the knob to selectively engage with either of the first seat or the second seat of the housing. The knob is pivotally attached to the base with a pivot pin for allowing the latch member of the knob to be moved relative to the housing and to be selectively engaged with either of the seats of the housing, and thus for allowing the knob to be easily actuated or operated by the user, and for allowing the working life of the pet retractor to be suitably increased.

The housing includes a guide member having a guide slot formed in the guide member and communicating with the chamber of the housing for slidably receiving and engaging with the leash. The leash includes a hook device and a stop attached to the leash for limiting the leash to move relative to the housing. The housing includes two side walls for forming the guide channel between the side walls of the housing.

The lock device includes at least one anchor extended from the base for engaging with the ratchet teeth of the rotary member and for limiting the rotary member to rotate relative to the housing. The housing includes a guide member extended into the guide channel of the housing, and the lock device includes a groove formed in the anchor for slidably receiving or engaging with the guide member and for guiding and limiting the base to move or slide relative to the housing.

The base includes a compartment formed therein for receiving and engaging with the spring biasing element. The rotary member includes a hub rotatably engaged with the spindle of the housing, and the spring biasing member includes a first end portion secured to the spindle of the housing, and a second end portion secured to the hub of the rotary member with a lock pin.

The base includes two ears extended therefrom, and the knob includes a pivot pin engaged with the ears for pivotally attaching the knob to the base, and for allowing the latch member of the knob to be moved relative to the housing and to be selectively engaged with either of the seats of the housing. The housing includes a projection extended into the guide channel of the housing for forming the first seat and the second seat in the housing. The housing includes a shield slidably engaged onto the knob and slidably engaged with the housing for partially shielding the guide channel of the housing and for protecting the knob.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a pet retractor in accordance with the present invention;

FIG. 2 is another perspective view of the pet retractor, in which a portion of the housing has been cut off for showing the inner structure of the pet retractor;

FIG. 3 is a partial exploded view of the pet retractor;

FIG. 4 is a cross sectional view of the pet retractor, taken along lines 4-4 of FIG. 1; and

FIGS. 5, 6, 7 are cross sectional views similar to FIG. 4, illustrating the operation of the pet retractor.

### DETAILED DESCRIPTION OF THE PREFERRED EMBODIMENT

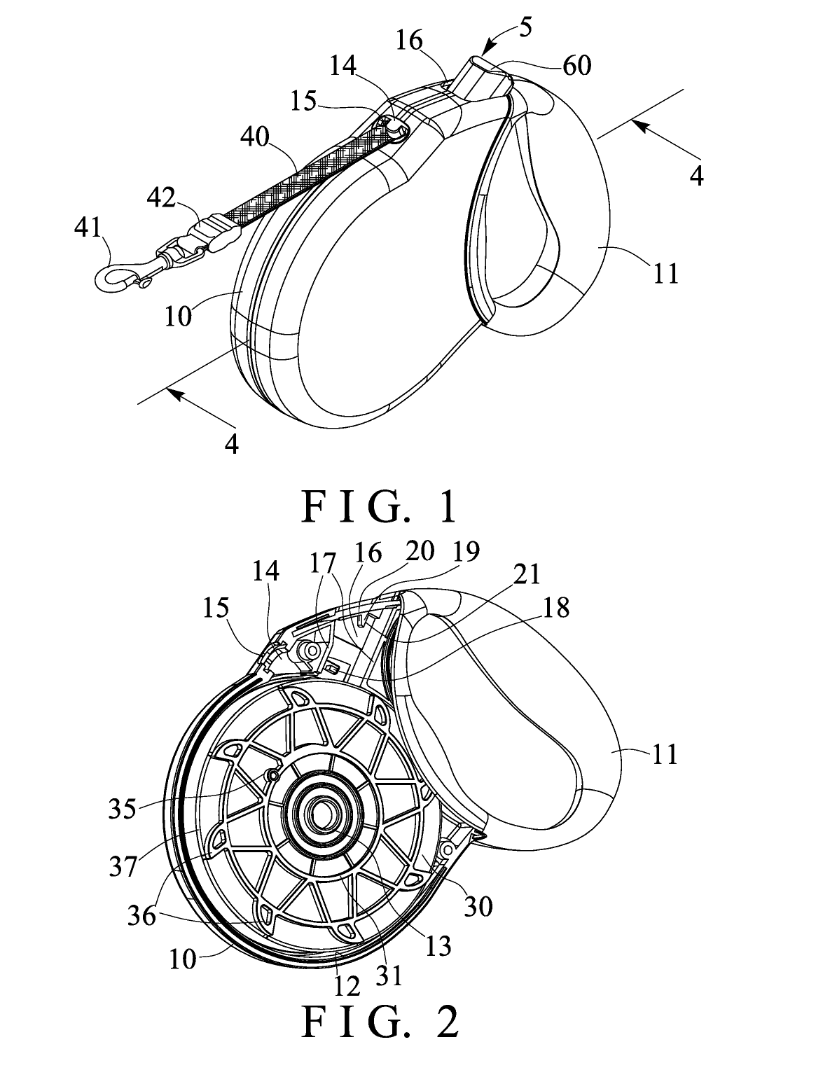

Referring to the drawings, and initially to FIGS. 1-4, a pet retractor in accordance with the present invention comprises an outer receptacle or housing 10 including a hand grip or handle 11 formed or provided thereon for being gripped or grasped or held by the user and for allowing the user to actuate or operate the pet retractor, the housing 10 includes a compartment or chamber 12 formed therein, and includes a hub or spindle 13 formed or provided therein or extended in the chamber 12 of the housing 10, and includes a guide member 14 having a guide slot 15 formed therein and communicating with the chamber 12 of the housing 10 for slidably receiving or engaging with a belt or leash 40 for pet or the like.

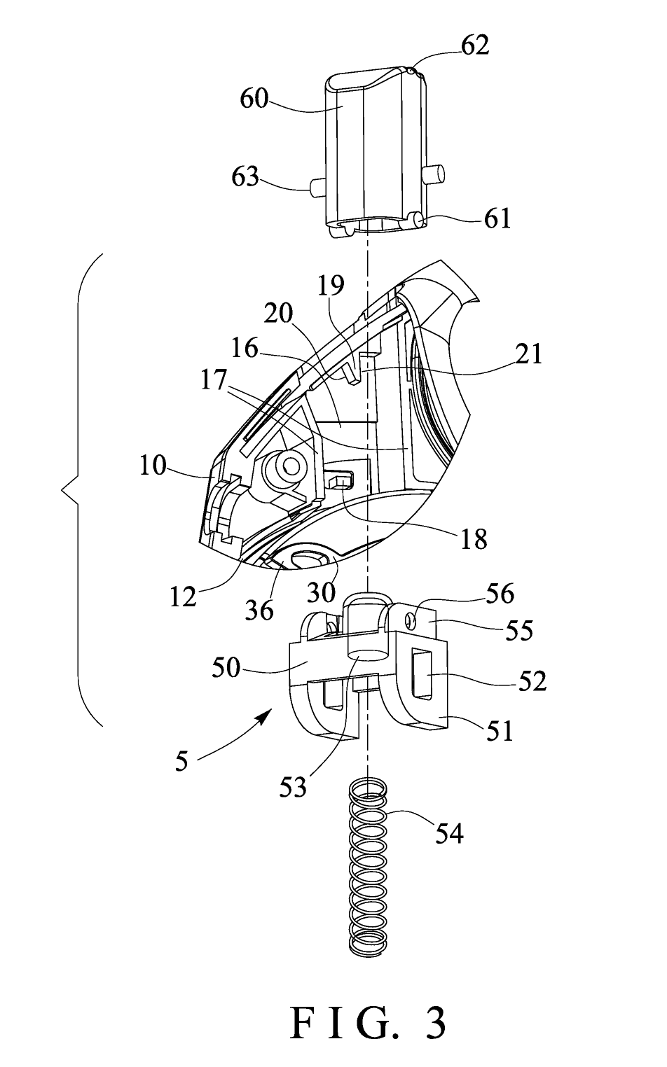

The housing 10 further includes a guide groove or channel 16 formed therein (FIGS. 2-3) and formed or defined between two side walls 17 and also communicating with the chamber 12 of the housing 10, and includes a guide key or member 18 extended into the guide channel 16 of the housing 10, and includes a guide tongue or projection 19 also extended into the guide channel 16 of the housing 10 for forming or defining two recesses or seats 20, 21 in the housing 10, for example, one of the seats 20 is a relatively shallower or first seat 20, and the other seats 21 is a relatively deeper or second seat 21, which will be described in further details hereinafter. As shown in FIGS. 1 and 4-7, a safety snap hook device 41 and a stop 42 are attached or mounted to the outer or free end portion of the leash 40.

A pulley or rotary member 30 is rotatably received or engaged in the chamber 12 of the housing 10 for winding or receiving or engaging with the pet leash 40, and the rotary member 30 includes a cylindrical member or hub 31 rotatably engaged onto or with the spindle 13 of the housing 10 and rotatable relative to the housing 10 around the spindle 13 of the housing 10, a spring biasing member 32 is disposed or engaged in the hub 31 of the rotary member 30 and mounted or secured between the hub 31 of the rotary member 30 and the spindle 13 of the housing 10 for biasing and forcing the rotary member 30 to rotate relative to the housing 10 or for recovering the rotary member 30.

For example, the spring biasing member 32 includes one or first end portion 33 secured to the spindle 13 of the housing 10, and the other or second end portion 34 secured to the hub 31 of the rotary member 30 with a lock pin 35 or the like. The rotary member 30 includes a number of ratchet teeth 36 extended axially and outwardly therefrom, such as extended axially and outwardly from the outer peripheral portion 37 of the rotary member 30 for engaging with a latch or lock device 5 and for limiting or guiding the rotary member 30 to rotate relative to the housing 10, which will be described in further details hereinafter.

As shown in FIGS. 3-7, the lock device 5 includes a base 50 slidably received or engaged in the guide channel 16 of the housing 10 and extendible or engageable into the chamber 12 of the housing 10 for selectively contacting or engaging with the ratchet teeth 36 of the rotary member 30, best shown in FIGS. 5-7, and the base 50 includes one or more (such as two) flaps or anchors 51 extended therefrom, and each anchor 51 include an oblong hole or groove 52 formed therein for slidably receiving or engaging with the guide member 18 and for guiding and limiting the base 50 of the lock device 5 to slide or move relative to the housing 10. The base 50 includes a chamber or compartment 53 formed therein (FIG. 3) for receiving or engaging with a spring biasing element 54.

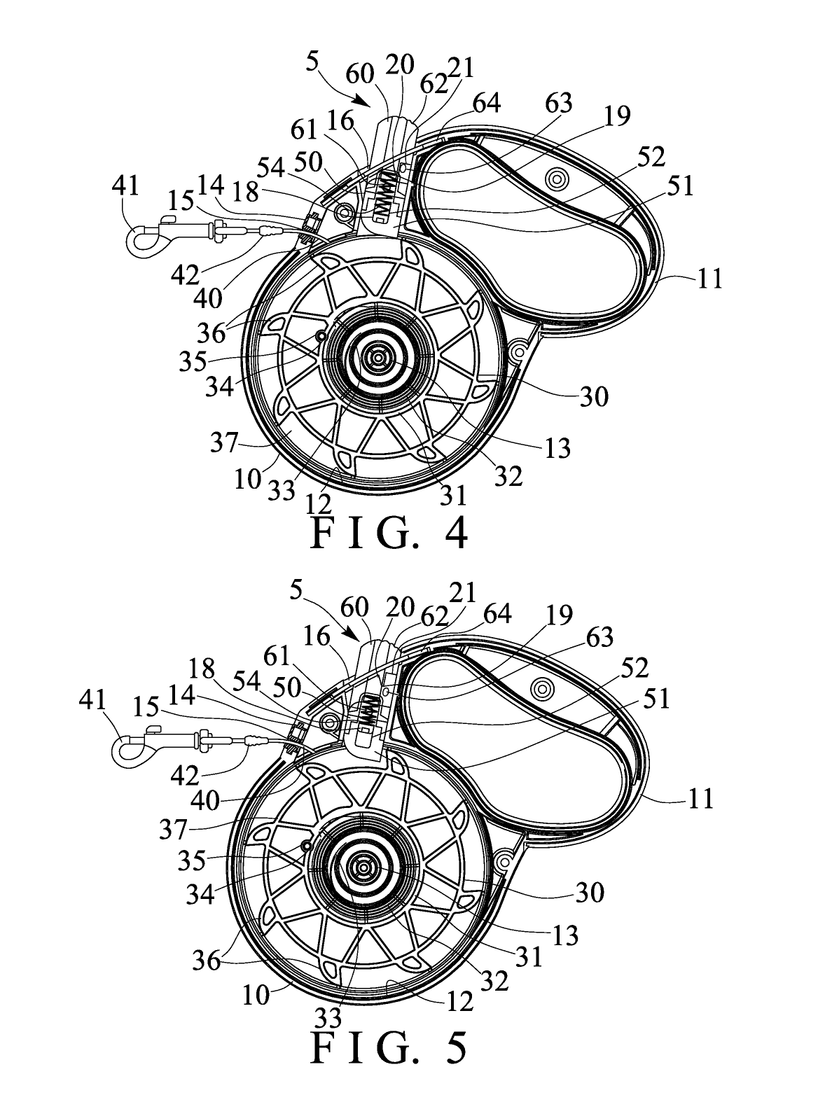

As shown in FIGS. 4-7, the spring biasing element 54 is engaged between the base 50 and the guide member 18 of the housing 10 for biasing and forcing the base 50 of the lock device 5 to slide or move away from the ratchet teeth 36 of the rotary member 30. The base 50 further includes one or more (such as two) ears 55 extended therefrom, and each ear 55 include an orifice 56 formed therein. The lock device 5 further includes a button or knob 60 having a pivot pin 61 engaged with the orifices 56 of the ears 55 for pivotally or rotatably attaching or mounting or securing the knob 60 to the base 50, the knob 60 is also slidably received or engaged in the guide channel 16 of the housing 10 and includes a rough or knurled surface 62 formed or provided therein for allowing the user to frictionally moving or pivoting the knob 60 relative to the base 50.

The knob 60 is partially extendible out of the housing 10 and further includes a latch member 63 extended therefrom for selectively contacting or engaging with the projection 19 of the housing 10 and for selectively engaging with either of the seats 20, 21 of the housing 10. For example, as shown in FIG. 4, when the latch member 63 of the knob 60 is engaged with the relatively deeper or second seat 21 of the housing 10, the spring biasing element 54 may bias and move the anchors 51 of the base 50 away from the rotary member 30 and disengaged or separated from the ratchet teeth 36, such that the rotary member 30 may be rotated freely relative to the housing 10 and such that the leash 40 may be freely pulled out of the housing 10. A cover or shield 64 may be slidably engaged onto the knob 60 and slidably engaged with the housing 10 for blocking or shielding the guide channel 16 of the housing 10.

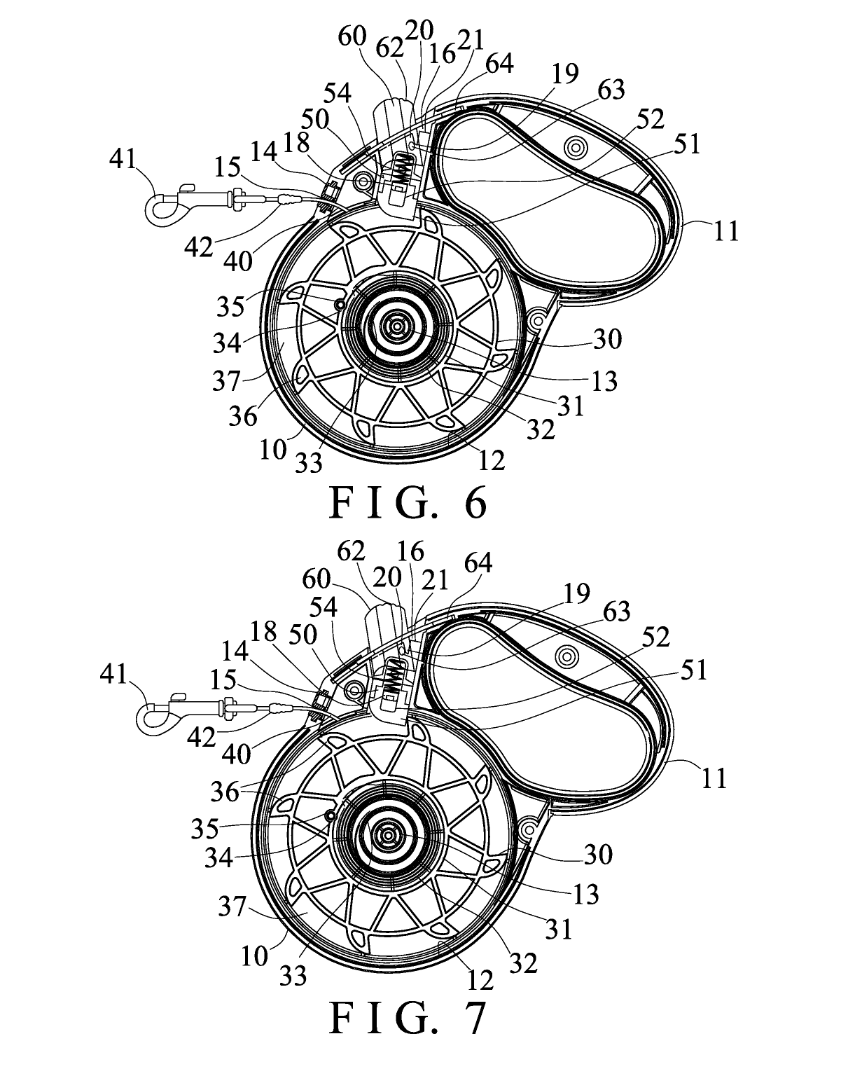

As shown in FIGS. 4-7, the knob 60 and the base 50 may be depressed or forced toward the rotary member 30 against the spring biasing element 54 (FIG. 5) to engage the anchors 51 of the base 50 into the rotary member 30 and to disengage or separate the latch member 63 of the knob 60 from the projection 19 of the housing 10, and the knob 60 may then be pivoted or rotated relative to the base 50 to move the latch member 63 over the projection 19 (FIG. 6) and to allow the latch member 63 of the knob 60 to engage with the relatively shallower or first seat 20 (FIG. 7) and then to allow the anchors 51 of the base 50 to be in engagement with the ratchet teeth 36 of the rotary member 30 selectively, and to prevent the rotary member 30 from being pivoted or rotated backwardly relative to the housing 10, and thus for preventing the leash 40 from being pulled out of the housing 10.

It is to be noted that the knob 60 is pivotally attached to the base 50 with the pivot pin 61 for allowing the knob 60 to be pivoted or rotated relative to the base 50 and thus for allowing the latch member 63 of the knob 60 to be moved over the projection 19 of the housing 10 and to be selectively engaged with either of the relatively deeper or second seat 21 or the relatively shallower or first seat 20 of the housing 10, and thus for allowing the knob 60 to be easily actuated or operated by the user, and for allowing the working life of the locking mechanism for the pet retractor to be suitably increased. When the latch member 63 of the knob 60 is engaged with the relatively deeper or second seat 21 of the housing 10 again (FIG. 4), the rotary member 30 may be rotated freely relative to the housing 10 and the leash 40 may be freely pulled out of the housing 10.

Accordingly, the pet retractor in accordance with the present invention includes a locking mechanism for solidly and stably locking and releasing the cable or cord, and for being easily actuated or operated by the user, and for increasing the working life of the locking mechanism for the pet retractor.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pet retractor comprising:
a housing including a chamber formed therein, and including a spindle provided in said chamber of said housing, and including a guide channel formed in said housing and communicating with said chamber of said housing, said housing including a first seat and a second seat provided therein,
a rotary member rotatably engaged in said chamber of said housing for engaging with a pet leash, and said rotary member being rotatably engaged with said spindle of said housing, said rotary member including a plurality of ratchet teeth extended therefrom,
a spring biasing member engaged between said rotary member and said housing for recovering said rotary member relative to said housing, and
a lock device including a base slidably engaged in said guide channel of said housing and engageable into said chamber of said housing for engaging with said ratchet teeth of said rotary member, a knob pivotally attached to said base and slidably received and engaged in said guide channel of said housing and partially extendible out of said housing, said knob including a latch member extended therefrom for selectively engaging with either of said first seat or said second seat of said housing, and a spring biasing element engaged between said base and said housing for biasing and forcing said base to move away from said ratchet teeth of said rotary member, and for biasing and forcing said latch member of said knob to selectively engage with either of said first seat or said second seat of said housing.

2. The pet retractor as claimed in claim 1, wherein said housing includes a guide member having a guide slot formed in said guide member and communicating with said chamber of said housing for engaging with said leash.

3. The pet retractor as claimed in claim 1, wherein said leash includes a hook device and a stop attached to said leash.

4. The pet retractor as claimed in claim 1, wherein said housing includes two side walls for forming said guide channel between said side walls of said housing.

5. The pet retractor as claimed in claim 1, wherein said lock device includes at least one anchor extended from said base for engaging with said ratchet teeth of said rotary member.

6. The pet retractor as claimed in claim 5, wherein said housing includes a guide member extended into said guide channel of said housing, and said lock device includes a groove formed in said at least one anchor for slidably engaging with said guide member and for guiding and limiting said base to slide relative to said housing.

7. The pet retractor as claimed in claim 1, wherein said base includes a compartment formed therein for receiving and engaging with said spring biasing element.

8. The pet retractor as claimed in claim 1, wherein said rotary member includes a hub rotatably engaged with said spindle of said housing, and said spring biasing member includes a first end portion secured to said spindle of said housing, and a second end portion secured to said hub of said rotary member with a lock pin.

9. The pet retractor as claimed in claim 1, wherein said base includes two ears extended therefrom, and said knob includes a pivot pin engaged with said ears for pivotally attaching said knob to said base.

10. The pet retractor as claimed in claim 1, wherein said housing includes a projection extended into said guide channel of said housing for forming said first seat and said second seat in said housing.

11. The pet retractor as claimed in claim 1, wherein said housing includes a shield slidably engaged onto said knob and slidably engaged with said housing for shielding said guide channel of said housing.
